(19) United States
(12) Patent Application Publication
(10) Pub. No.: US 2005/0240517 A1
(43) Pub. Date: Oct. 27, 2005

(54) Automatically administering a non-disinvesting policy loan on an insurance contract

(75) Inventors: Bernard H. Wolzenski, St. Louis, MO (US); Mark M. Hopfinger, Fenton, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: RGA Reinsurance Company, Chesterfield, MO (US)

(21) Appl. No.: 11/075,003

(22) Filed: Mar. 8, 2005

Related U.S. Application Data
(60) Provisional application No. 60/564,806, filed on Apr. 23, 2004.

(51) Int. Cl. G06F 17/60

(52) U.S. Cl. 705/38

(57) ABSTRACT

A computerized system and method for administering non-disinvesting policy loans on insurance contracts. Grant or denial of a non-disinvesting policy loan on an insurance contract is based on market conditions and specific policy data. The invention administers such a loan in compliance with state insurance laws and security requirements, including the transfer of funds among policy sub-accounts without liquidating the funds before transfer and/or the transfer of non-disinvesting policy loans as appropriate.

### TECHNICAL FIELD

This invention relates generally to administering a non-disinvesting policy loan on a life insurance policy and, particularly, to computerized systems and methods for automatically administering such a loan including maintaining an adequate value of sub-accounts of the policy, without liquidation, as collateral for the loan.

### BACKGROUND OF THE INVENTION

Those knowledgeable in the insurance industry are familiar with two main types of life insurance contracts or policies, namely, term life insurance and permanent life insurance. Unlike a term life insurance policy, a permanent life insurance policy can build up a cash value and generally stays in force as long as the policy owner continues to pay the premiums.

One category of permanent life insurance is variable life insurance. A variable life insurance policy is basically a combination of a permanent life insurance policy and an investment account. All or part of each premium paid by the policy owner is invested and the cash value and death benefit amounts of the policy depend on how well the investments perform. In other words, the cash value and the death benefit of the variable life insurance policy fluctuate relative to the performance of one or more investment sub-accounts. Typical investment sub-accounts include investments in mutual funds, diversified portfolios of stocks and/or bonds, money market accounts or the like. Moreover, the cash value of the policy provides a source of funds from which the policy owner can borrow, or it can be used as collateral to help secure a loan. Such loans are often referred to in the industry as standard policy loans. Current state insurance laws limit the rate that can be charged on a standard policy loan based on, for example, an established financial indicator. Similarly, policy loans may be made on indexed general account insurance products and the like.

A conventional standard policy loan on a variable life insurance policy, for example, requires liquidation of funds in the policy's sub-accounts as security for the loan. The loan amount is then held in a notional account, for example, until the loan is repaid. Upon loan repayment, the funds from this account, typically referred to as a loan account, are reinvested in policy sub-accounts. Thus, when a policy owner makes a standard policy loan on a variable life insurance policy, the insurance company will liquidate investments in the policy's sub-accounts before granting the loan against the policy. Under these circumstances, any additional gains (or losses) that the investments in the various policy sub-accounts might have yielded before the loan is repaid do not remain in the sub-accounts. The policy loan provision that is currently in universal use excludes any policy loan amount from participating in either the variable sub-account performance or the index performance. In other words, the policy loan provisions in current use for both variable and indexed insurance products are “disinvesting” as to the normal basis for determining investment credits. Presently, a disinvesting loan such as the standard policy loan described above is the only type of policy loan available to a variable or indexed general account life insurance policy owner.

In light of the foregoing, there is a desire for a mechanism permitting non-disinvesting policy loans on variable or indexed contracts or the like that a lender, such as a life insurance company, can make securely without liquidating funds in policy sub-accounts. Moreover, because of the difficulty and complexity in continually evaluating performance among several sub-accounts and operating in compliance with state insurance laws, there is a desire for the automated administration of policy loans, including automated sub-account transfers and automated transfers between non-disinvesting and standard policy loans to sufficiently protect the lender. In addition, improvements are needed to permit collaboration between insurance companies, reinsurers, and lenders in providing funds for and administering such non-disinvesting policy loans.

### SUMMARY OF THE INVENTION

Embodiments of the invention overcome one or more deficiencies in the prior art by enabling, among other things, an insurance company or the like to determine whether to grant a non-disinvesting policy loan, which does not require the liquidation of investments, from an insurance policy. The invention further permits administering such loans to provide sufficient security and in compliance with requirements of state insurance laws pertaining to policy loans. Moreover, the features of the present invention described herein are less laborious and easier to implement than currently available techniques, provide greater security for the loan, and enable such loans to be economically feasible and commercially practical for the first time.

Briefly described, a method embodying aspects of the invention is for administering a non-disinvesting loan on an insurance policy. In this instance, the policy has funds that are invested in one or more investment sub-accounts. The method includes receiving sub-account data associated with one or more of the sub-accounts of the policy. The sub-account data relates to a value of the sub-accounts as well as sub-account composition, correlations to market indices, and covariance estimates. The method also includes computing tentative loan availability parameters for the sub-accounts of the policy based on the sub-account data associated with them, receiving market interest rate information, and computing final loan availability parameters for the sub-accounts of the policy based on the tentative loan availability parameters and the market interest rate information. An available loan amount for a non-disinvesting loan on the sub-accounts of the policy is determined based on the final loan availability parameters and the value of each of the sub-accounts.

In another embodiment, a method for administering a non-disinvesting loan on an insurance policy includes receiving sub-account data associated with each of the policy's investment sub-accounts. The method also includes computing a tentative loan availability parameter for each of the sub-accounts of the policy based on the sub-account data associated with them, receiving market interest rate information, and computing a final loan availability parameter for each of the sub-accounts of the policy based on the tentative loan availability parameter and the market interest rate information. A decision on whether to grant or deny a request for a non-disinvesting loan on one or more of the sub-accounts of the policy is rendered based on the final loan availability parameters, the value of each of the sub-accounts, and the amount of the requested loan.

Yet another embodiment of the invention relates to a network that administers a non-disinvesting loan on an insurance policy. The network has an administration system server associated with an insurer granting the policy. The server receives and responds to sub-account data associated with one or more of the policy's investment sub-accounts. The server is configured to access a processing module that computes tentative loan availability parameters for the sub-accounts of the policy based on the sub-account data associated with them. The server is further configured to access a processing module that computes final loan availability parameters for the sub-accounts of the policy based on the tentative loan availability parameters and market interest rate information.

Computer-readable media having computer-executable instructions embody further aspects of the invention.

Alternatively, the invention may comprise various other methods and apparatuses.

Other features will be in part apparent and in part pointed out hereinafter.

### BRIEF DESCRIPTION OF THE DRAWINGS

FIG. 1 is a block diagram illustrating an exemplary network environment in which the present invention may be utilized for administering a non-disinvesting policy loan of an insurance contract and maintaining funding in a plurality of sub-accounts of the policy as a security for the policy loan.

FIG. 2A and FIG. 2B are exemplary flow diagrams illustrating process flow according to one embodiment of the invention for administering a non-disinvesting policy loan of an insurance contract and maintaining funding in the sub-accounts to provide adequate security for the non-disinvesting policy loan.

FIG. 3 is a block diagram illustrating exemplary operation of a reinsurance conduit according to an embodiment of the invention.

FIG. 4 is a block diagram illustrating exemplary process flow according to an alternative embodiment of the invention for administering a non-disinvesting policy loan of an insurance contract and maintaining funding in a plurality of sub-accounts of the policy as a security for the policy loan.

Corresponding reference characters indicate corresponding parts throughout the drawings.

### DETAILED DESCRIPTION OF THE INVENTION

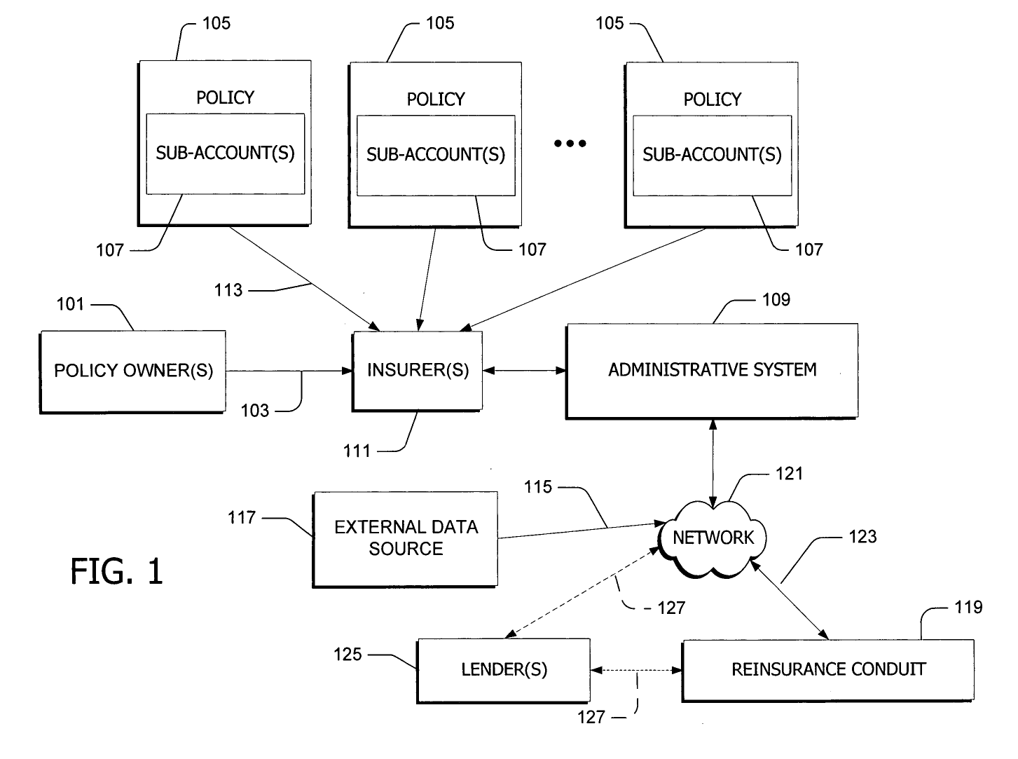

Referring now to the drawings, FIG. 1 illustrates an exemplary network environment in which the present invention may be utilized. The invention relates to computerized means for granting and administering a non-disinvesting policy loan on, for example, a variable life insurance policy without reducing the aggregate funds in the policy's sub-accounts. In addition, the invention continually evaluates performance of the sub-accounts in light of market information, including statutory rate limits and the like. For example, most current state insurance laws limit the rate that can be charged on a policy loan based on an established financial indicator. To provide security for the lender, the invention enables sub-account transfers as well as transfers between non-disinvesting and standard policy loans.

In FIG. 1, an exemplary block diagram illustrates a system for administering a request for a non-disinvesting policy loan of a variable insurance contract and maintaining funding in a plurality of sub-accounts of the policy as a security for the policy loan. A policy owner 101 makes a request at 103 for a non-disinvesting policy loan based on a variable insurance contract or policy 105. In one embodiment of the invention, the loan request, referred to as LP for later calculations, may be a request for a non-disinvesting policy loan at 103 to pay the premium of policy 105. In another embodiment of the invention, the loan request at 103, referred to as LX for later calculations, may be a request for a non-disinvesting policy loan for reasons other than to pay the premium of policy 105.

The policy 105 in the embodiment of FIG. 1 combines the traditional benefit of permanent life insurance with the ability to invest the cash value of the policy 105 in various investment sub-accounts 107 (e.g., stocks, bonds, mutual funds, etc.). In addition, policy 105 may have a number of general accounts or fixed accounts, not including a loan account. General or fixed accounts are those in which the life insurance company guarantees the principal and some minimum rate of interest, and may declare additional interest or credit amounts tied to an index. Therefore, the policy owner 101 may take the advantage of this cash value invested in sub-accounts 107 by making the loan request on the policy 105.

An administrative system 109 associated with an insurer 111 processes the loan request based on policy data, sub-account data, and interest rate information. In response to the request, the administrative system 109 of FIG. 1 gathers data at 113 related to policy 105. As an example, the data at 113 includes, but is not limited to, policy data from the records of the insurer 111, such as daily information of the amount of cash value in each sub-account 107 of the policy, the amount of any standard policy loans outstanding, the amount of any non-disinvesting policy loans outstanding, the insured's age, the policy anniversary date, the amount of the variable insurance contract, the current allocation percentages of net premiums to sub-accounts 107, and the premium rate classification. In addition, the data at 113 to be processed by administrative system 109 includes sub-account data related to each sub-account 107 under the policy 105. In one embodiment of the present invention, the sub-account data used for processing the request includes, but is not limited to, sub-account performance metrics (e.g., alpha, Beta and R-squared measured against the appropriate index and correlation coefficients for each pair of sub-accounts as described in APPENDIX A). In another embodiment, the administrative system 109 provides only elementary sub-account data to a processing module (“PM”) 115, which calculates the necessary performance metrics.

Although described in the context of a variable life insurance policy, it is to be understood that aspects of the invention permit non-disinvesting policy loans on variable or indexed contracts or the like.

As described above, most current state insurance laws limit the rate that can be charged on a policy loan based on an established financial indicator. One such indicator is the Moody's Corporate Bond Yield Average—Monthly Average Corporates, as published by Moody's Investor Service, from two months before the month in which the loan rate is set. Before processing the loan request from the administrative system 109, the PM 115 receives financial information from an external data source 117 (e.g., public databases) at 119. For example, PM 115 receives quarterly, semi-annual, or annual London InterBank Offered Rates (LIBOR) and the Moody's Corporate Bond Yield Average—Monthly Average Corporates for the past several months (e.g., 15). In a preferred embodiment, the administrative system 109 forwards the loan request, policy data, and sub-account data to PM 115 via a data communication network 121. In other words, the administrative system 109 receives the loan request at 103 and the data at 113 relating to policy 105 and sub-accounts 107. The PM 115 receives the interest rate information at 119 and all other information from the administrative system via the network as shown at 123. In the alternative, the calculation, decision-making, and instruction capabilities of the PM 115 are built directly into the administrative system 109.

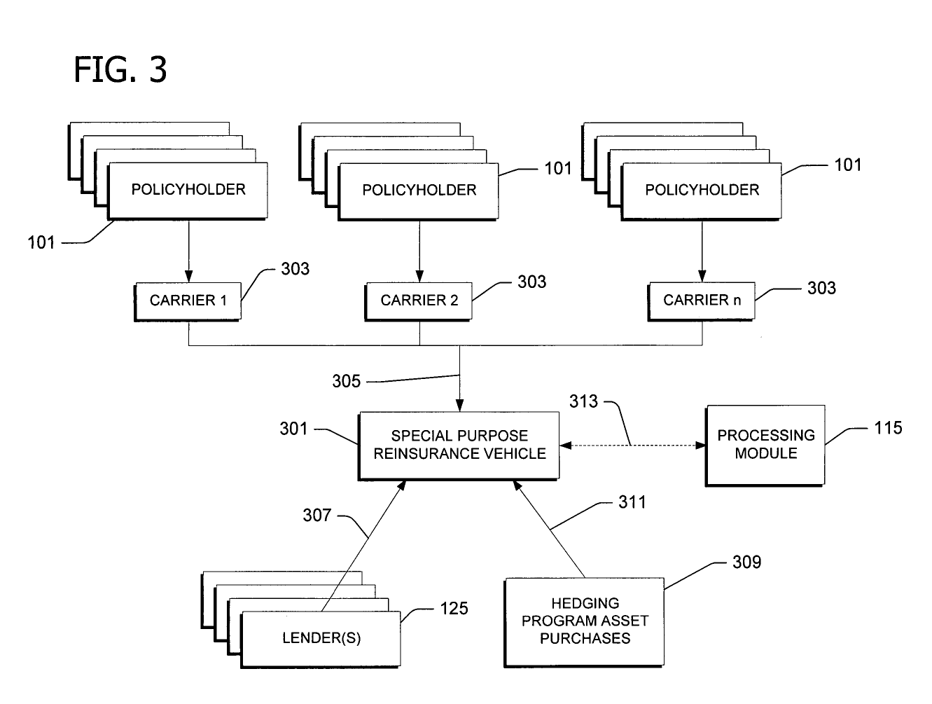

Referring further to FIG. 1, PM 115, either as a separate processing system or as incorporated into administrative system 109, evaluates and processes a loan request according to the non-disinvesting loan structure of the present invention. In one embodiment, the funding of the non-disinvesting policy loans occurs through a reinsurance structure illustrated generally by a reinsurance conduit (e.g., reinsurance conduit 301 of FIG. 3).

The functioning of the reinsurance conduit is described below with respect to FIG. 3. In one embodiment, direct writing carriers are responsible for implementing a link to the PM (which supports the non-disinvesting policy loan provisions) in from their administrative systems, and for filing appropriate rider forms and prospectus supplements.

Once the loan request is processed, PM 115 signals the administrative system 109 of the grant or denial. In the case where the request is approved, the administrative system 109 may issue an approved policy loan to the policy owner 101.

In other words, a non-disinvesting loan structure according to embodiments of the present invention involves policy owner 101 paying premiums on his or her respective policy 105, receiving a policy loan, and repaying the loan. In this example, a direct writing life insurance company such as insurer 111 issues the policy, makes the loan to policy owner 101, and receives the premium payments and loan repayments. Direct writing carriers may finance the loans through a reinsurance conduit, or special purpose reinsurance vehicle, as shown in FIG. 3.

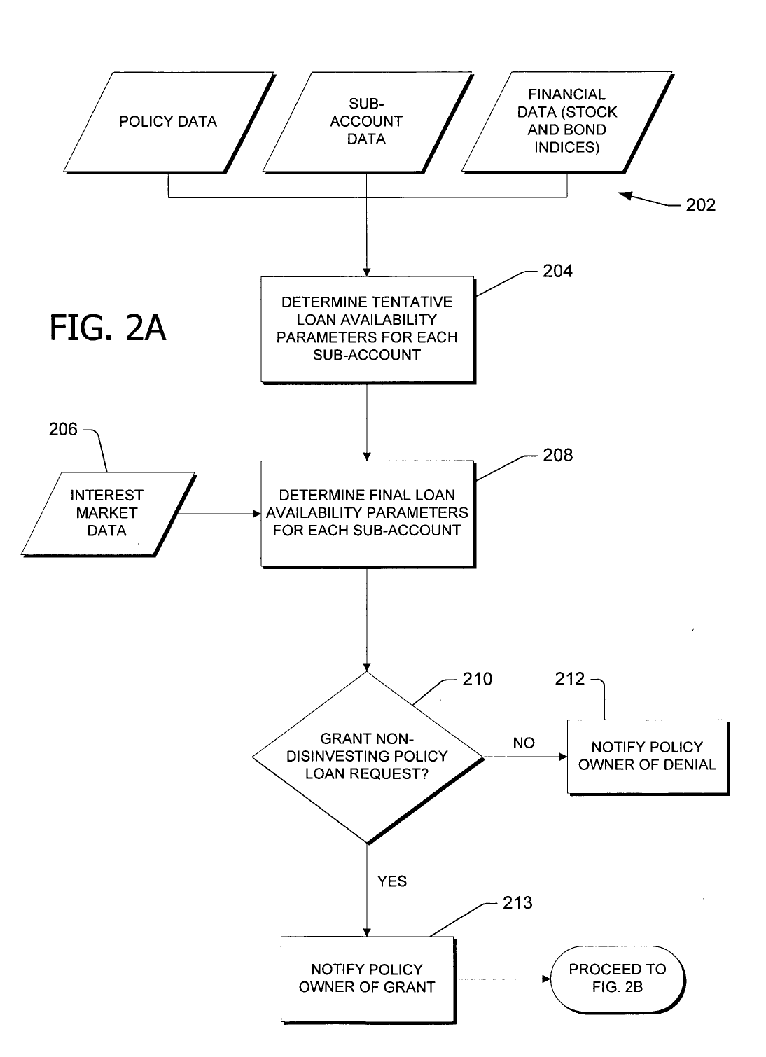

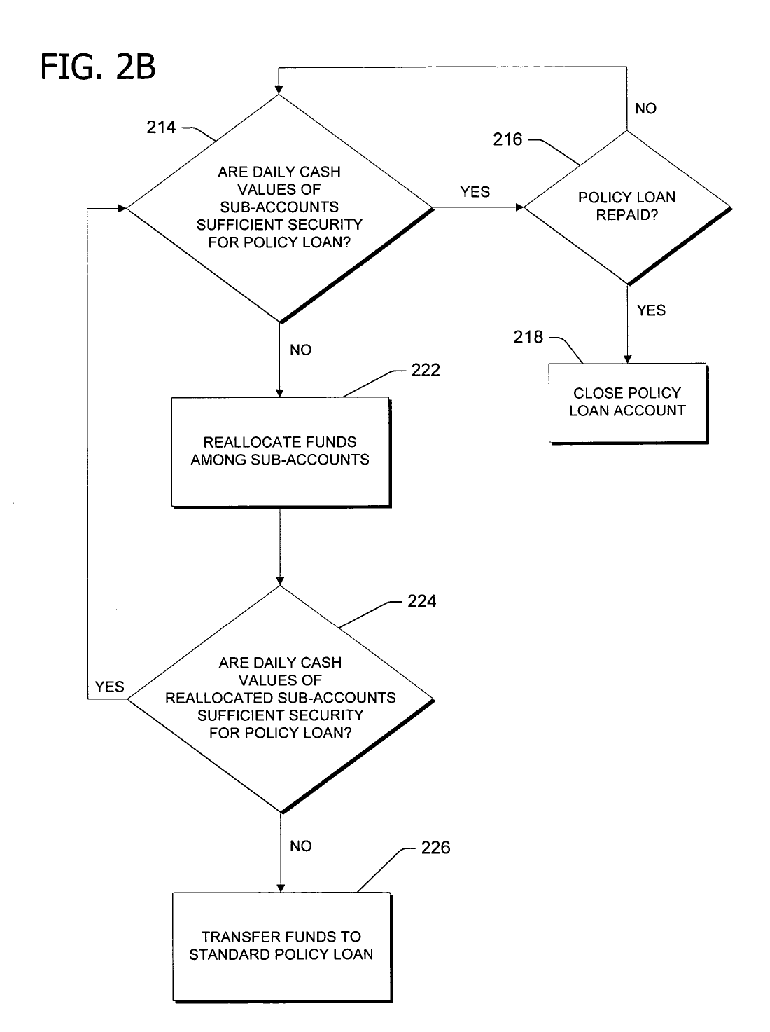

Referring now to FIG. 2A and FIG. 2B, an exemplary flow diagram illustrates an embodiment of the invention for administering a non-disinvesting policy loan of a variable insurance contract 105 and maintaining funding in sub-accounts 107 to provide adequate security for the non-disinvesting policy loan. Embodiments of the present invention generally perform several functions including, but not limited to the following: evaluating sub-account data and market conditions and setting loan availability parameters; evaluating interest market conditions and overriding loan availability parameters, if appropriate; evaluating requests for non-disinvesting policy loans to pay premiums; evaluating requests for non-disinvesting policy loans other than to pay premiums; evaluating current loan status and reallocating funds among sub-accounts if necessary; and evaluating current loan status and transferring the non-disinvesting loan to a standard policy loan if necessary.

In one embodiment, beginning at 202, the PM 115 receives data related to the non-disinvesting policy loan and sub-accounts of the policy from the administrative system 109 and financial data from external data sources (e.g. public data bases). The server PM executes instructions for computing the tentative loan availability parameters at 204 by analyzing the data related to policy and sub-accounts and the market condition data. At 206, PM 115 receives, for example, state insurance law limits on interest rates that insurer 111 is permitted to charge policy owner 101, and other market rates. At 208, PM 115 determines the final loan availability parameters by analyzing the tentative loan availability parameters and the state insurance law limits on interest rates.

As part of the evaluations at 204 and 208 described above, embodiments of the present invention evaluate sub-account data and market conditions and set loan availability parameters. The security for a non-disinvesting policy loan consists of shares in policy sub-accounts 107 that fluctuate in value. For this reason, the invention performs ongoing market analysis to determine the adequacy of the security for the loan. The data used for this analysis includes specific information about the performance and volatility of each sub-account 107 as well as data on general market conditions. The invention processes this data to set tentative loan availability parameters relative to each sub-account and in total at 204. The system may also consider the use of options to enhance the security of the sub-accounts.

As described above, the invention at 208 also evaluates interest market conditions and overrides loan availability parameters if appropriate. Policy loan interest rates that a life insurance company is permitted to charge are subject to conditions set forth in the insurance codes of the states. At the same time, interest rates in the economy independently determine the cost that insurer 111 pays to obtain the funds needed to provide the non-disinvesting policy loan. If the cost of funds to insurer 111 exceeds the loan interest rates that it is permitted to charge, insurer 111 may need to limit the availability of new or renewing non-disinvesting policy loans. The invention processes the data on market interest rates as well the-data that determines permissible rates under state insurance laws. It then determines whether to override the tentative loan availability parameters, and if so what the new parameters should be. The system may also consider the use of options, futures, and other derivatives to manage risk and enhance the overall security of the program.

The PM 115 in this embodiment then decides whether to grant or deny the policy loan request at 210. For example, the PM 115 determines whether to grant or deny the loan request based on a set of formulas for calculating either a premium loan request or another loan request, as described in detail below.

In addition, PM 115 evaluates requests for non-disinvesting policy loans to pay premiums. Requests of this type should be granted or declined by insurance companies based on a number of factors. In one embodiment, the invention determines the proper response by taking into account the size of the non-disinvesting policy loan request, the amount of any outstanding policy loans, the amount of cash value in each sub-account, the current allocation percentages of net premiums to sub-accounts, the amount of life insurance, the age and risk classification of the insured, the policy anniversary date, and the loan availability parameters of each sub-account. With respect to requests for non-disinvesting policy loans other than to pay premiums, the invention does not use current allocation percentages of net premiums to sub-accounts 107. Also, the loan availability parameters for non-disinvesting policy loans other than to pay premiums may be different than for those to pay premiums. The invention determines whether these requests for non-disinvesting policy loans should be granted based on these factors.

If the loan request is denied, the policy owner 101 is notified at 212. If, on the other hand, the request is granted, the administrative system 109 receives notice of the grant itself, notifies the policy owner at 213, and proceeds to the operations shown in FIG. 2B. Administrative system 109 monitors sub-accounts 107 at regular intervals (e.g., daily) and provides data to the PM 115 to determine if the cash values of the sub-accounts 107 are sufficient security for the policy loan at 214. If the cash values provide sufficient security, administrative system 109 receives notice and continues to monitor sub-accounts 107 to determine when the policy loan has been repaid at 216. If the policy loan has not been repaid, administrative system 109 continues to monitor sub-accounts 107 daily and send data to PM 115 for evaluation. If, however, the policy loan has been repaid, the monitoring of the sub-accounts terminates and the policy loan account is closed at 218.

After 214, if the cash value is insufficient security for the policy loan, the PM 115 in one embodiment provides instructions to the administrative system 109 to reallocate funds among sub-accounts 107 at 222. Advantageously, this is done without reducing the total amount of the funds in sub-accounts 107. Then, the PM 115 determines whether such reallocation is sufficient to provide adequate security for the policy loan at 224. If the reallocation is sufficient, then PM 115, for example, instructs administrative system 109 to perform the appropriate reallocation and return to monitoring at 214 to make a daily determination of the cash value in sub-accounts 107. On the other hand, if the reallocation provides insufficient security for the policy loan, PM 115 instructs administrative system 109 to transfer some or all of the funds in the outstanding policy loan to a standard policy loan at 226.

According to embodiments of the invention, several parameters factor into the decision to grant or deny a particular non-disinvesting policy loan and the interest rate to be charged on the loan. The following description sets forth exemplary calculations executed by PM 115.

A maximum loan factor, MLF, for each sub-account 107 is the maximum permitted ratio of non-disinvesting policy loans to cash value in that sub-account. The MLF may be different for different sub-accounts 107. When policy loans are made under a standard policy loan provision, the loan account is used. The invention calculates a maximum alternative (non-disinvesting) loan balance, MALB, for non-disinvesting policy loan based on the sum of the cross products of the MLF for each sub-account 107 (including the general or fixed account, but not the loan account), multiplied by the amount of cash value in that sub-account, plus any surrender credit, and minus any surrender charge. But the MALB is not permitted to exceed the total cash value, TCV, in the sub-accounts 107 (other than the loan account) minus any surrender charge.

For example, if the cross product of MLF for a money market sub-account and the total cash value in all sub-accounts, minus any surrender charge, is greater than the alternative (non-disinvesting) policy loan balance, ALB, then the cash value may be transferred from all other sub-accounts on a pro-rata basis to the money market sub-account until ALB no longer exceeds MALB for the policy. Further to the example, if the cross product of MLF for the money market sub-account and the total cash value in all sub-accounts, minus any surrender charge, is less than or equal to ALB, then policy loan amounts are transferred from the non-disinvesting policy loan provision to the standard policy loan provision until the ALB no longer exceeds MALB for the policy.

The following are used in the exemplary calculations:
LP=amount of an alternative (non-disinvesting) policy loan request, proceeds to be applied as a premium
LX=amount of an alternative (non-disinvesting) policy loan request, proceeds not to be applied as a premium
i^{APL}=current interest rate charged on alternative (non-disinvesting) policy loans
i^{SPL}=current interest rate charged on standard policy loans
n=number of variable sub-accounts
g=number of general accounts or fixed accounts, not including the loan account
n+g=total number of sub-accounts including those in the general account or fixed account
TCV=total cash value, before any surrender charges or credits, excluding any standard policy loans (loan account values)
SC=surrender charge (−) or credit (+)
SV=surrender value, after any surrender charges or credits
CVₜ=cash value in variable sub-account t, 1≦t≦n
CV₁=cash value in the money market account (variable sub-account 1=money market)
CVₙ₊ₜ=cash value in sub-account (n+t) in the general account or fixed account, 0≦t≦g
SLB=standard policy loan balance
ALB=alternative (non-disinvesting) policy loan balance
MALB=maximum alternative (non-disinvesting) policy loan balance
MLFₜ=maximum loan factor for cash value in sub-account t
% P=applicable percent of premium load for the current policy year
% ALLOCₜ=% allocation for new premium to sub-account

$$t , {\sum }_{t = 1}^{n + g} {ALLOC}_{t} = 1$$
PY_{frac}=fraction of the current policy year remaining from the end of the business day

As described above, in an embodiment in which PM 115 assesses and approves the policy loan, the PM 115 may instruct 138 the administrative system 109 to monitor 140 the sub-accounts 107 on a periodic basis, preferably daily. This is because the security of the non-disinvesting policy loan consists of shares of the cash value of sub-accounts 107 of the policy 105, and the cash value of the sub-accounts 107 may vary daily depending on the performance of the underlying investment accounts. Therefore, in order to maintain an adequate security for the policy loan, the PM 115 may instruct the administrative system 109 to reallocate the funds among the sub-accounts 107, if necessary, to ensure adequate security for the loan. As an example, the invention performs the following calculations at the end of each business day using the cash value of the sub-accounts 107:

$$TCV = {\sum }_{t = 1}^{n + g} {CV}_{{t}_{{}_{{}_{t}}}}$$

$$SV = TCV + SC$$

$$MALB = [ Min ( {\sum }_{t = 1}^{n + g} {CV}_{t} * {MLF}_{t} + SC , Min ( TCV , TCV + SC ) ) ] / ( 1 + Max ( {i}^{APL} , {i}^{SPL} ) * {PY}_{frac} )$$

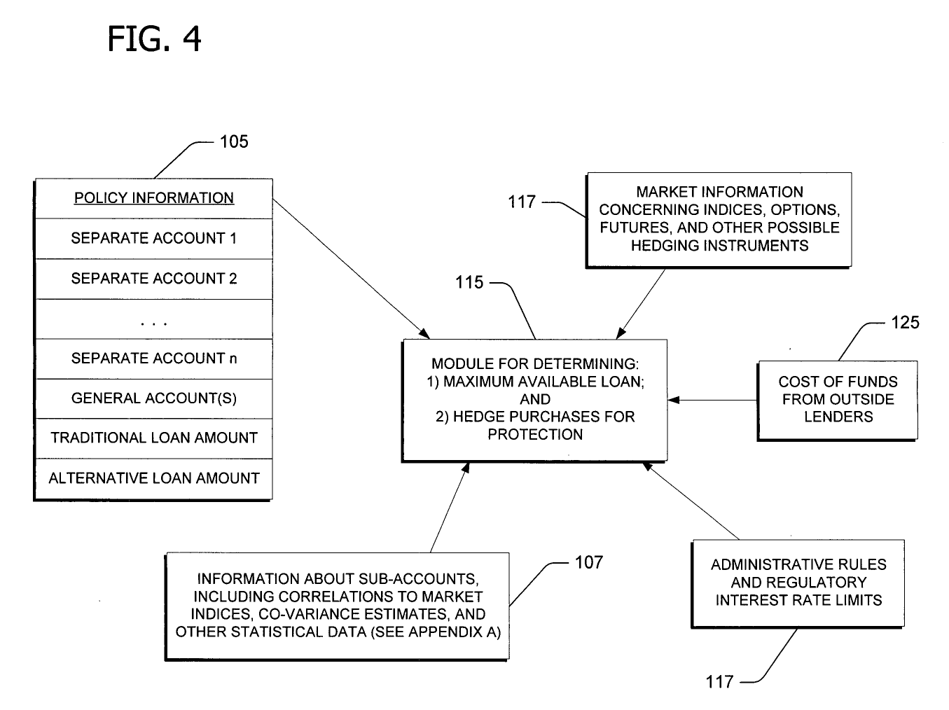

If ALB>MALB, then:
   If ALB≦(TCV*MLF₁+SC) and ALB≦Min(TCV,TCV+SC), then solve for reallocation amounts; else liquidate alternative (non-disinvesting) policy loan
   If ALB≦MALB, then check for premium loan request
      APPENDIX A defines the factors that would be used in an alternative calculation approach reflecting correlations and diversification benefits of the sub-accounts, as illustrated in FIG. 4.

As illustrated above, the invention determines whether the cash values of the sub-accounts 107 are sufficient security to the approved policy loan. In a preferred embodiment, the PM 115 may determine the exact amount of reallocation of funds among the sub-accounts 107. This is accomplished by analyzing the data about each sub-account 107 with the final loan availability parameters derived during the initial granting of the loan request. The invention performs the following to solve for the reallocation amounts:
Let M=amount of cash value reallocated to money market sub-account
CVₜ^{new}=new cash value in sub-account t
Then CV₁^{new}=CV₁+M.
Let CV₋₁=cash value outside the money market sub-account=TCV−CV₁

$$\begin{matrix}Then {CV}_{- 1}^{new} = {CV}_{- 1} - M \\ Let {MLF}_{- 1} = {\sum }_{t = 2}^{n + g} {MLF}_{t} * {CV}_{t} / {\sum }_{t = 2}^{n + g} {CV}_{t} \\ Then M = ( ALB - MALB ) / ( {MLF}_{1} - {MLF}_{- 1} ) \\ {CV}_{t}^{new} = {CV}_{t} * ( {CV}_{- 1} - M ) / {CV}_{- 1}\end{matrix}$$
Set CVₜ=CVₜ^{new} for all t for any subsequent calculations
Go to check for premium loan request
   More generally, replacing the money market fund with a pre-determined set of asset allocation models selected by the customer, the system may determine if reallocating part or all of the assets to one of these models results in an acceptable relationship between ALB and MALB. Should the asset performance subsequently improve, the system may permit reallocation of assets back to their original allocation levels.

As a result of the above calculations to determine the exact amount to be transferred among the sub-accounts 107, there is no need to reduce the aggregate amount of the investments in the sub-accounts 107. In fact, this embodiment of the invention enables the PM 115 to maximize the return on the investment of the policy owner 101 while maintaining an adequate security for the policy loan without liquidating the investment.

The invention also enables the PM 115 to transfer some or the entire outstanding non-disinvesting policy loan to a standard policy loan. This is desirable when the reallocation of funds among the sub-accounts 107 is insufficient to provide adequate security for the approved policy loan 112. In this instance, the invention performs the following calculations to liquidate the non-disinvesting policy loan:
Let R=amount of alternative (non-disinvesting) policy loan transferred to standard policy loan
R=ALB−MALB
Let ALB^{new}, SLB^{new} be the new alternative (non-disinvesting) and standard loan balances after transfer
ALB^{new}=ALB−R
SLB^{new}=SLB+R
CVₜ^{new}=CVₜ−R*CVₜ/TCV for all t
Set ALB and SLB equal to their new values for any subsequent calculations
Go to check for premium loan request

In making its determination, PM 115 evaluates the cash value of the sub-accounts 107 and the final loan availability parameters. In one embodiment where the request is for a non-disinvesting policy loan to pay the premium of the policy 105, LP, the PM 115 takes the following information, among others, into account: the final loan availability parameters for each sub-account, the size of the non-disinvesting policy loan request 103, the amount of any outstanding policy loans, the amount of cash value in each sub-account 107, the current allocation percentages of net premiums to sub-accounts 107, the amount of policy 105, the age and risk classification of the policy owner 101, the policy 105 anniversary date, and the loan availability parameters of each sub-account 107. The module performs the following calculations to determine the granting or denial of the request for a non-disinvesting policy loan to pay the premium policy 105, LP and provides instructions for the administrative system 109. The check for premium loan request is calculated according to:
If LP=0, then go to check for other loan request
Let PremALB %=increase in MALB per dollar of premium paid by alternative (non-disinvesting) policy loan

$$PremALB \% = ( 1 - \% P ) * {\sum }_{t = 1}^{n + g} {MLF}_{t} * \% {ALLOC}_{t}$$
Let MLP=maximum allowable alternative (non-disinvesting) policy loan to pay premium
MLP=(MALB−ALB)/(1-PremALB %)
If LP≦MLP then execute premium loan request; else deny premium loan request
In one embodiment of the invention, the premium loan request is executed by:
Let ALB^{new}=alternative loan balance after the premium loan
ALB^{new}=ALB+LP
Process premium transaction for premium of LP
Go to check for other loan request

In the event the premium loan request is denied, neither the loan request nor the premium transaction is processed. A letter may be sent to policy owner 101 stating that the non-disinvesting loan amount requested is unavailable, that the maximum alternative loan available was MLP on the date that the request was processed, and that this amount changes daily.

In another embodiment in which the request is for a non-disinvesting policy loan to pay other than premium of the policy 105, LX, the PM 115 takes the following information, among others, into account: the final loan availability parameters for each sub-account, the size of the non-disinvesting policy loan request, the amount of any outstanding policy loans, the amount of cash value in each sub-account 107, the amount of policy 105, the age and risk classification of the policy owner 101, the policy 105 anniversary date, and the loan availability parameters of each sub-account 107. In a preferred embodiment, the administrative system 109 determines the purpose of the loan request before forwarding it to PM 115. In addition, the final loan availability parameters for each sub-account may be different depending on the purpose of the loan request. The invention performs the following calculations to determine the granting or denial of the request for a non-disinvesting policy loan to pay other than the premium policy 105, LX. A check for another loan request may be performed according to:
If LX=0 then go to end
Let MLX=maximum allowable alternative (non-disinvesting) policy loan other than to pay premium
MLX=MALB−ALB
If LX≦MLX then execute other loan request; else deny other loan request

In one embodiment, executing the other loan request involves:
Let ALB^{new}=alternative loan balances after the other loan
ALB^{new}=ALB+LX
Go to end

In the event the other loan request is also denied, the loan request is not processed. A letter may be sent to policy owner 101 stating that the non-disinvesting loan amount requested is unavailable, that the maximum alternative loan available was MLX on the date that the request was processed, and that this amount changes daily.

In operation, a policy owner 101 of a variable insurance contract requests for a non-disinvesting policy loan with his/her insurance company. The administrative system of the insurance company forwards the policy data and the sub-account data to the PM to grant or deny the request. If the PM determines to grant the policy loan request, the system signals the administrative system of such decision. The PM continues to monitor the cash value of the sub-accounts daily to ensure that is an adequate security for the policy loan. If necessary, the PM would calculate the exact amount of the finds to be reallocated among the sub-accounts. The PM would automatically, without reducing the total finds in the sub-accounts, transfer the exact amount among the sub-accounts. Furthermore, if the PM determines the reallocation of funds among the sub-accounts are insufficient to provide adequate security for the loan, the PM would instruct the administrative system to initiate a transfer of some or the entire outstanding non-disinvesting policy loan to a standard policy loan.

Referring now to FIG. 3, reinsurance conduit 301 comprises a special purpose reinsurance vehicle (SPRV) according to one embodiment of the invention. The SPRV 301 is a reinsurance entity specifically established for the purpose of providing funds to a plurality of carriers 303 offering the non-disinvesting policy loan program according to embodiments of the invention, and managing the risks associated with such a program. The primary risks are (1) the sufficiency of the interest payments to cover the lender financing costs, and (2) the adequacy of the collateral to repay the loan principal. The processing module 115 has several inputs as described in FIG. 1, or alternatively in FIG. 4. SPRV 301 will generally evaluate the non-disinvesting policy loan program, its willingness to provide additional funding, and any requirement to reduce or eliminate loan funding based on the cost of funds, required capital, cost of any hedging programs, and the loan spread available. The cost of hedging programs includes any guarantees provided on the adequacy of collateral (such as may be provided by an affiliate of the patent holder), as well as options, futures, swaps and direct asset purchases to minimize the likelihood of loss or to increase the overall security of the program for the benefit of the lenders.

Reference character 305 refers to a set of agreements with direct carriers 303 where the reinsurer, via SPRV 301, finances the loans made by the direct carriers 303. Under the agreement, direct carrier 303 grants certain rights to SPRV 301 to set parameters for the non-disinvesting policy loan program. The agreement is generally a full participation in the amounts reinsured, including the interest charged, loan repayments, and the like. The SPRV 301 in this embodiment reimburses expenses associated with the loans (e.g., licensing fees, administration costs), usually on a formula basis.

At 307, SPRV 301 also enters into a set of agreements with loan providers 125. These agreements typically specify a loan rate formula or process, funding commitment (amounts and duration), and orderly exit provisions. They also place restrictions on SPRV 301, such as requiring hedging programs to be in place.

In the illustrated embodiment, SPRV 301 considers hedging program asset purchases 309 at 311. They can include any number and type of arrangements. One such arrangement is a stop-loss agreement to protect carrier 303 against the insufficiency of the collateral securing policy loans (e.g., if a loan's collateral falls below the outstanding loan, the stop-loss pays the difference between the net amount received from the separate accounts and the outstanding loan balance including interest). This agreement may be net of other hedges. Other arrangements may include the purchase of options on equity indices, futures, direct investments, and interest rate instruments such as caps, floors, and options.

At 313, PM 115 takes as input information on all of the arrangements of SPRV 301 and provides recommendations on the security for existing non-disinvesting policy loans and for approval of new non-disinvesting policy loans, as well as recommendations regarding purchase or sale of hedges. For example, the processing module 115 may limit the portion of the net available spread (after funding costs) available to purchase certain hedges. After deciding on the most effective hedges, the security may be considered more effective than without the hedge purchase. PM 115 may map each sub-account as a weighted average of indices, and use the correlation of the indices to determine net exposures to the various indices.

FIG. 4 is a block diagram illustrating exemplary process flow according to an alternative embodiment of the invention for administering a non-disinvesting policy loan of a variable insurance contract and maintaining funding in a plurality of sub-accounts of the policy as a security for the policy loan. FIG. 4 illustrates inputs for an evaluation module (such as PM 115) applicable when financing is provided via a reinsurance program according to an alternative embodiment of the invention. This takes advantage of the utilization of hedges to either increase maximum available loans, or to protect existing loans without requiring repayment and/or asset reallocation.

Other embodiments of the system may use approaches based on VAR and ETL-like methodologies to determine maximum loan amounts based on, for example, covariance benefits amongst investment options in the policy, required asset allocation/reallocation strategies, the use of derivatives to hedge risk, other components in the insurance product structure, and the time horizon for ultimate loan settlement.

Although described in connection with an exemplary computing system environment, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

The order of execution or performance of the methods illustrated and described herein is not essential, unless otherwise specified. That is, elements of the methods may be performed in any order, unless otherwise specified, and that the methods may include more or less elements than those disclosed herein.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

APPENDIX A

R-Squared vs. Standard Index: R-squared ranges from 0 to 100 and reflects the percentage of a fund's movements that are explained by movements in its benchmark index. An R-squared of 100 means that all movements of a fund are completely explained by movements in the index. Thus, index funds that invest only in S&P 500 stocks will have an R-squared very close to 100. Conversely, a low R-squared indicates that very few of the fund's movements are explained by movements in its benchmark index. An R-squared measure of 35, for example, means that only 35% of the fund's movements can be explained by movements in its benchmark index. Therefore, R-squared can be used to ascertain the significance of a particular beta or alpha. Generally, a higher R-squared will indicate a more useful beta figure. If the R-squared is lower, then the beta is less relevant to the fund's performance.

Beta vs. Standard Index: Beta, a component of Modem Portfolio Theory statistics, is a measure of a fund's sensitivity to market movements. It measures the relationship between a fund's excess return over T-bills and the excess return of the benchmark index. Equity funds are compared with the S&P 500 index; bond funds are compared with the Lehman Brothers Aggregate Bond index. Morningstar calculates beta using the same regression equation as the one used for alpha, which regresses excess return for the fund against excess return for the index. This approach differs slightly from other methodologies that rely on a regression of raw returns.

By definition, the beta of the benchmark (in this case, an index) is 1.00. Accordingly, a fund with a 1.10 beta has performed 10% better than its benchmark index—after deducting the T-bill rate—than the index in up markets and 10% worse in down markets, assuming all other factors remain constant. Conversely, a beta of 0.85 indicates that the fund has performed 15% worse than the index in up markets and 15% better in down markets. A low beta does not imply that the fund has a low level of volatility, though; rather, a low beta means only that the funds market-related risk is low. A specialty fund that invests primarily in gold, for example, will often have a low beta (and a low R-squared), relative to the S&P 500 index, as its performance is tied more closely to the price of gold and gold-mining stocks than to the overall stock market. Thus, though the specialty fund might fluctuate wildly because of rapid changes in gold prices, its beta relative to the S&P may remain low.

Alpha vs. Standard Index: Alpha measures the difference between a fund's actual returns and its expected performance, given its level of risk (as measured by beta). A positive alpha figure indicates the fund has performed better than its beta would predict. In contrast, a negative alpha indicates a fund has underperformed, given the expectations established by the fund's beta. Some investors see alpha as a measurement of the value added or subtracted by a fund's manager. There are limitations to alpha's ability to accurately depict a manager's added or subtracted value. In some cases, a negative alpha can result from the expenses that are present in the fund figures but are not present in the figures of the comparison index. Alpha is dependent on the accuracy of beta: If the investor accepts beta as a conclusive definition of risk, a positive alpha would be a conclusive indicator of good fund performance. Of course, the value of beta is dependent on another statistic, known as R-squared. (Alpha, beta, and R-squared statistics are all provided on Morningstar.com.)

For Alpha vs. the Standard Index, Morningstar performs its calculations using the S&P 500 as the benchmark index for equity funds and the Lehman Brothers Aggregate as the benchmark index for bond funds. Morningstar deducts the current return of the 90-day T-bill from the total return of both the fund and the benchmark index. The difference is called the fund's excess return. The exact mathematical definition of alpha that Morningstar uses is shown below:
Alpha=Excess Return−((Beta×(Benchmark−Treasury))
Benchmark=Total Return of Benchmark Index
Treasury=Return on Three-month Treasury Bill

Value at Risk (VAR): VAR summarizes the predicted maximum loss (or worst loss) over a target horizon within a given confidence interval.

Conditional Tail Expectation, or Expected Tail Loss (ETL), is a refinement of the VAR methodology. The ETL is the expected value of the loss given that a loss occurs in excess of VAR.

1. A method for administering a non-disinvesting loan on an insurance policy, said policy having funds invested in one or more investment sub-accounts, said method comprising:
receiving sub-account data associated with one or more of the sub-accounts of the policy, said sub-account data relating to a value of the sub-accounts;
computing a tentative loan availability parameter for the sub-accounts of the policy based on the sub-account data associated therewith;
receiving market interest rate information;
computing a final loan availability parameter for-the sub-accounts of the policy based on the tentative loan availability parameter and the market interest rate information; and
determining an available loan amount for a non-disinvesting loan on one or more of the sub-accounts of the policy based on the final loan availability parameter and the value of each of the sub-accounts.

2. The method of claim 1, further comprising rendering a decision on whether to grant or deny a request for the loan based on the final loan availability parameter, the value of each of the sub-accounts, and the amount of the requested loan.

3. The method of claim 2, providing notice of the loan grant or denial decision to an insurer granting the policy.

4. The method of claim 1, wherein receiving the sub-account data includes receiving the sub-account data from an insurer granting the policy.

5. The method of claim 1, wherein the sub-account data includes information representative of one or more of the following financial characteristics of the sub-accounts: performance and variability.

6. The method of claim 1, wherein the sub-account data relates to one or more of the following: amount of cash value in each of the sub accounts of the policy and current application percentages of net premiums to the sub-accounts.

7. The method of claim 1, further comprising receiving financial information relating to one or more stock and bond indices, and wherein the tentative loan availability parameter for the sub-accounts of the policy is also based on the financial information.

8. The method of claim 1, wherein receiving the market interest rate information comprises receiving the market interest rate information from an external source.

9. The method of claim 1, further comprising receiving information relating to interest rate limits set by state insurance laws.

10. The method of claim 9, wherein the final loan availability parameter specifies a desired interest rate for the policy loan and wherein computing the final loan availability parameter for each of the sub-accounts of the policy comprises comparing the desired interest rate for the policy loan to the interest rate limits set by state insurance laws.

11. The method of claim 1, wherein the insurance policy comprises a variable insurance policy having funds invested in one or more of the following sub-accounts: mutual funds, diversified portfolios of stocks and/or bonds, and money market.

12. The method of claim 1, further comprising reallocating funds invested in the sub-accounts among the sub-accounts to ensure the value of the sub-accounts provides adequate security for the loan.

13. The method of claim 12, further comprising transferring the loan to a disinvesting loan if reallocating the funds invested in the sub-accounts fails to ensure that the value of the sub-accounts provides adequate security for the loan.

14. The method of claim 12, wherein reallocating the funds invested in the sub-accounts includes updating the final loan availability parameter daily and reallocating the funds in the sub-accounts as a function of the updated final loan availability parameter.

15. The method of claim 1, further comprising receiving policy data associated with the policy for use in computing the tentative loan availability parameter, said policy data relating to one or more of the following: amount of any disinvesting loans outstanding related to a policy owner, amount of any non-disinvesting loans outstanding related to the policy owner, the age of the policy owner, the anniversary date of the policy, the amount of the policy, and premium rate classification.

16. The method of claim 1, further comprising financing the non-disinvesting loan via a special purpose reinsurance vehicle.

17. The method of claim 16, further comprising hedging by the reinsurance vehicle.

18. The method of claim 1, wherein determining the available loan amount for the non-disinvesting loan includes determining whether the loan is to be used for paying one or more premiums of the policy.

19. One or more computer-readable media having computer-executable instructions for performing the method of claim 1.

20. A method for administering a non-disinvesting loan on an insurance policy, said policy having funds invested in one or more investment sub-accounts, said method comprising:
receiving sub-account data associated with each of the sub-accounts of the policy, said sub-account data relating to a value of each of the sub-accounts;
computing a tentative loan availability parameter for each of the sub-accounts of the policy based on the sub-account data associated therewith;
receiving market interest rate information;
computing a final loan availability parameter for each of the sub-accounts of the policy based on the tentative loan availability parameter and the market interest rate information; and
rendering a decision on whether to grant or deny a request for a non-disinvesting loan based on the final loan availability parameter, the value of each of the sub-accounts, and the amount of the requested loan.

21. A network for administering a non-disinvesting loan on an insurance policy comprising an administration system server associated with an insurer granting the policy, said policy having funds invested in one or more investment sub-accounts, said server receiving and responsive to sub-account data associated with one or more of the sub-accounts of the policy, said sub-account data relating to a value of the sub-accounts, said server being configured to access a processing module that computes a tentative loan availability parameter for the sub-accounts of the policy based on the sub-account data associated therewith, said server being further configured to access a processing module that computes a final loan availability parameter for the sub-accounts of the policy based on the tentative loan availability parameter and market interest rate information.

22. The network of claim 21, wherein the server is configured to access the processing module to determine an available loan amount for a non-disinvesting loan based on the final loan availability parameters and the value of each of the sub-accounts.

23. The network of claim 21, further comprising a first database associated with the server for storing the sub-account data.

24. The network of claim 21, further comprising a second database associated with the server for storing the market interest rate information.

25. The network of claim 21, wherein the server is configured to access the processing module to render a decision on whether to grant or deny a request for the loan based on the final loan availability parameter, the value of each of the sub-accounts, and the amount of the requested loan.

26. The network of claim 21, further comprising a special purpose reinsurance vehicle for financing the non-disinvesting policy loan.

27. The network of claim 21, wherein the sub-account data includes information representative of one or more of the following financial characteristics of the sub-accounts: performance and variability.

28. The network of claim 21, wherein the sub-account data relates to one or more of the following: amount of cash value in each of the sub accounts of the policy and current application percentages of net premiums to the sub-accounts.

29. The network of claim 21, wherein the tentative loan availability parameters for the sub-accounts of the policy are also based on financial information relating to one or more stock and bond indices.

30. The network of claim 21, further comprising an external data source coupled to the administration system server via a data communication network for providing the market interest rate information.

31. The network of claim 21, wherein the final loan availability parameter specifies a desired interest rate for the policy loan and wherein the server is configured to access the processing module to compares the desired interest rate for the policy loan to an interest rate limits set by one or more state insurance laws.

32. The network of claim 21, wherein the insurance policy comprises a variable insurance policy having funds invested in one or more of the following sub-accounts: mutual fund, diversified portfolios of stocks and/or bonds, and money market.

33. The network of claim 21, wherein the server is configured to reallocate funds invested in the sub-accounts among the sub-accounts to access the processing module to ensure the value of the sub-accounts provides adequate security for the loan.

34. The network of claim 33, wherein the server is further configured to access the processing module to transfer the loan to a disinvesting loan if reallocating the funds invested in the sub-accounts fails to ensure that the value of the sub-accounts provides adequate security for the loan.

35. The network of claim 21, wherein the tentative loan availability parameters, are also a function of one or more of the following policy data: amount of any disinvesting loans outstanding related to a policy owner, amount of any non-disinvesting loans outstanding related to the policy owner, the age of the policy owner, the anniversary date of the policy, the amount of the policy, and premium rate classification.
